(19) United States
(12) Patent Application Publication
(10) Pub. No.: US 2005/0077703 A1
(43) Pub. Date: Apr. 14, 2005

(54) Steering system for agricultural chemical airblast sprayer

(76) Inventor: Airton Hiroto Tango, Pompeia (BR)

Correspondence Address: STRIKER, STRIKER & STENBY, 103 EAST NECK ROAD, HUNTINGTON, NY, 11743, US

(21) Appl. No.: 10/950,923

(22) Filed: Sep. 27, 2004

(30) Foreign Application Priority Data
Sep. 25, 2003 (BR) PI-0303881-5

(51) Int. Cl. B62D 13/00; B60D 1/00

(52) U.S. Cl. 280/442

(57) ABSTRACT

“Improvement in the steering system for agricultural chemical airblast sprayer”, consisted of a front module (1) consisted of an articulated axle (3b) that moves according to the tractor maneuver and is interconnected through link bars (4) to a main trailer (5) which also has a system of articulated axle (8) that, in turn, is actuated from the front module (1) through link bars (6).

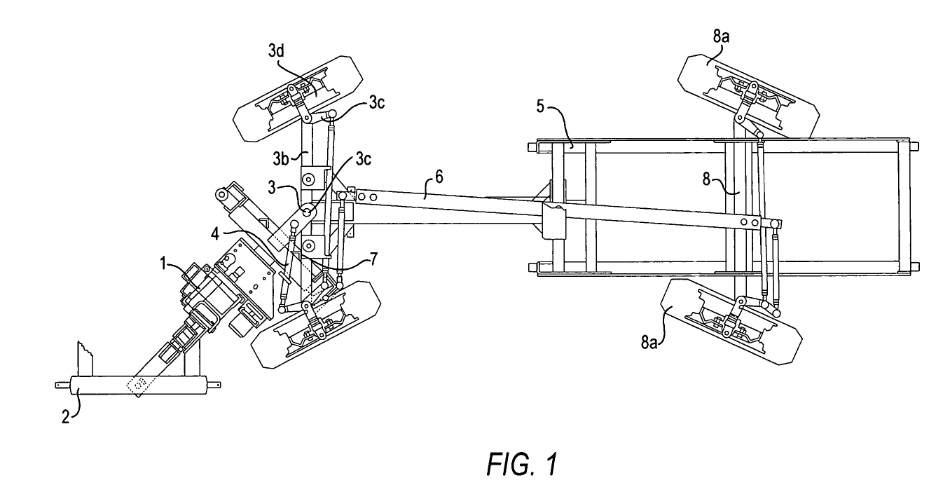

This report refers to an improvement in the steering system for a agricultural chemical airblast sprayer and more particularly to a chemical airblast sprayer used in the cultivation of grapes in trellis system.

As it is known by technicians in the subject, the cultivation of grapes in trellis system is one of the most traditional known ways of cultivation. This cultivation is of the creeping type that grows in rows, and its main ways of cultivation are T-, Y- or I-shaped where its bunches remain suspended in a perpendicular plane in relation to the ground, which facilitates the treatment and harvest of this planting type.

Due to the peculiarity of this culture, to make the spray application, the sprayer must pass through these rows, applying the products through systems that direct the air to the culture. Most of these rows are very close to each other (dense planting) which obliges the equipment to make maneuvers in relatively small spaces. Another problem is the equipment dynamic stability, because once it has a narrow track width, it can turn over easily.

Currently, there are some types of steering systems used in the cultivation of grapes in trellis system, however most equipment do not use steering systems, being consisted of conventional trailers and, as such, waste much time to making maneuvers at the end of the rows when there is limitation in the space for maneuvers.

Another problem verified, when such sprayers are used in the above mentioned cultures, refers to the low lateral stability, for the trailer must be supported by three points like a tricycle and also be narrower and shorter between the front support and the rear axle to provide a minimum radius for maneuvers.

To minimize these problems, there is a steering system called articulated axle consisted of a mechanism that directs the wheels of the airblast sprayer according maneuvering of the tractor, thus improving this operation; however such system continues to show problems regarding the machine stability.

Therefore one of the purposes of this invention is to provide an improvement to the steering system for agricultural chemical airblast sprayer that allows to make maneuvers in small spaces and that also has a dynamic stability of the assembly.

Another purpose of this invention is to provide an improvement to the steering system for agricultural chemical airblast sprayer that besides allowing a better maneuverability of the equipment, is consisted of a steering device capable of articulating the four wheels at the same time through link bars and by an independent front module that dispenses with the use of C. V. PTO shafts, thus obtaining a reduction in the space for maneuvers and an improvement in the dynamic stability of the equipment.

These and other purposes and advantages of this invention are reached with an improvement in the steering system for agricultural chemical airblast sprayer with a front module consisted of an articulated axle that moves according to the maneuvers of the tractor and is interconnected through link bars (tongue) to the main trailer which also has a system of articulated axle that, in turn, is actuated from the front module through the link bars (tongue).

More particularly, the improvement in the steering system for agricultural chemical airblast sprayer, object of this invention, is comprised by a steering device capable of articulating four wheels at the same time through link bars and by an independent front module consisted of an anterior stroke limiter that limits the movement of the tractor in relation to the front module; and the latter is posteriorly and centrally mounted to an axle bar, in whose ends the front wheels are mounted; being foreseen link bars that move said front wheels to the preset position defined by a stroke limiter that limits the movement of the front module in relation to the main trailer and allows the use of conventional PTO shafts; and the front axle bar is interconnected to the anterior end of the main tongue that is interconnected to the rear axle bar of the main trailer, and the rear wheels of the main trailer are moved by the main tongue that, in turn, is actuated by the link bars.

Hereinafter, this invention will be described in connection with the enclosed drawings, given in the quality of example without any limitative character, in which the unique figure is a schematic upper view of the improved steering system for agricultural chemical airblast sprayer;

According to this illustration, the improvement in the steering system for agricultural chemical airblast sprayer, object of this invention, is consisted of a front module (1) placed anterior to a stroke limiter (2) in the shape of transverse bar centrally pivoted to a longitudinal arm, and said limiter (2) is responsible for limiting the tractor movement in relation to the front module (1).

This front module (1) is posteriorly and centrally provided with a longitudinal bar with pivotal eye (3) on its posterior end which is fitted to a vertical turning shaft (3a) foreseen in a axle bar (3b) in whose ends are mounted the articulated axle ends (3c) that move the front wheels (3d) of the machine.

Still foreseen are link bars (4) that move said front wheels (3d) to a preset position determined by a stroke limiter (7) which function is to limit the movement of the front module (1) in relation to the main trailer (5) and allows the machine to use conventional PRO shafts.

To the bar of the front axle (3b) is connected the anterior end of a main tongue (6) whose posterior end is interconnected to a bar of the rear axle (8) of the main trailer (5), and the rear wheels (8a) of the main trailer (5) are moved by the main tongue (6) which, in turn, is actuated by the link bars (4).

Despite a preferred constructive conception has been described and illustrated, it is worth emphasizing that alterations to the design are possible and feasible without diverging from the scope of this invention.

1- “IMPROVEMENT IN THE STEERING SYSTEM FOR AGRICULTURAL CHEMICAL AIRBLAST SPRAYER”, wherein it is consisted of a front module (1) consisted of an articulated axle (3b) that moves according to the tractor maneuver and is interconnected through link bars (4) to a main trailer (5) which also has a system of articulated axle (8) that, in turn, is actuated from the front module (1) through link bars (6).

2- “IMPROVEMENT IN THE STEERING SYSTEM FOR AGRICULTURAL CHEMICAL AIRBLAST SPRAYER”, in accordance with claim 1, wherein it is consisted of a steering mechanism capable of articulating four wheels (3d, 8a) at the same time through link bars (4) and by an independent front module (1) consisted of an anterior stroke limiter (2) that limits the movement of the tractor in relation to the front module (1); and the latter is posteriorly and centrally mounted to an axle bar (3b) in whose ends are mounted the front wheels (3d) that move to the preset position defined by the stroke limiter (2); and in the front axle bar (3b) is interconnected the anterior end of a main tongue (6) that is interconnected to the rear axle bar (8) of the main trailer (5); and the rear wheels (8a) of the main trailer are moved by the main tongue (6) that, in turn, is actuated by the link bars (4).

3- “IMPROVEMENT IN THE STEERING SYSTEM FOR AGRICULTURAL CHEMICAL AIRBLAST SPRAYER”, in accordance with claim 1, wherein it is consisted a front module (1) anteriorly provided with a stroke limiter (2) in the shape of a transverse bar centrally pivoted to a longitudinal arm; and the front module (1) is posteriorly and centrally provided with a longitudinal bar with a pivotal eye (3) in its posterior end which is interconnected to a rotating vertical axle (3a) foreseen in an axle bar (3b) in whose ends are mounted the articulated axle ends (3c) that move the front wheels (3d) of the machine; being still foreseen link bars (4) that move said front wheels (3d) to the preset position defined by a stroke limiter (7) that limits the movement of the front module (1) in relation to the main trailer (5) and allows that the machine uses conventional PTO shafts; and to front axle bar (3b) is interconnected the anterior end of a main tongue (6) whose posterior end is interconnected to a rear axle bar (8) of the main trailer (5), and the rear wheels (8a) of the main tongue (5) are moved by the main tongue (6) that, in turn, is actuated by the link bars (4).
